(19) United States
(12) Patent Application Publication
(10) Pub. No.: US 2025/0212931 A1
(43) Pub. Date: Jul. 3, 2025

(54) SUSHI ROLLING APPARATUS WITH INDEPENDENTLY REPOSITIONABLE ROLLERS

(71) Applicant: Stephen Michael Pace, Panama City Beach, FL (US)

(72) Inventor: Stephen Michael Pace, Panama City Beach, FL (US)

(21) Appl. No.: 18/397,390

(22) Filed: Dec. 27, 2023

(51) Int. Cl. A23P 20/20; A23L 7/196; A23L 17/00; A23L 17/60

(52) U.S. Cl. CPC A23P 20/20; A23L 7/1963; A23L 7/1965; A23L 17/60; A23L 17/75

(57) ABSTRACT

A sushi roll forming apparatus has a horizontal base with parallel upstanding end walls; a first and a second roller having a longitudinally extending rod at each end, with the second roller parallel to the first roller; and a flexible sleeve suspended around the rollers. The end walls each have guide slots, with rests, that carry the rods slidably between the rests. A method of forming a sushi roll includes providing the sushi roll forming apparatus; spacing the first roller from the second roller to form an assembly deck; placing nori on the assembly deck; pressing sushi rice onto the nori; distributing filler ingredients longitudinally along the nori; urging the first and second rollers together; and rotating the first and second rollers, rolling the nori around the filler ingredients. The apparatus compresses and adheres rice to nori on an exterior of a sushi roll while compressing ingredients within the roll.

### BACKGROUND OF THE INVENTION

The present invention relates to a sushi rolling apparatus and, more particularly, to a sushi rolling apparatus with independently repositionable floating tension shafts.

Although there are many sushi-making machines, they are only capable of wrapping the rice on the inside of the nori (seaweed), resulting in inconsistently sized rolls, frequently causing the sushi to collapse while being consumed. Sushi industry standards as well as consumer expectations typically require that rice is adhered to the exterior of the sushi roll, resulting in a single-bite item. When nori is wrapped on the outside, it simply wilts and produces an unpleasant dining experience. Good sushi should have minimal rice with centered, well-articulated filling elements.

Commercially available rolling devices function similarly to a cigarette roller and only feed the nori onto an “endless belt” to wrap filler ingredients. They produce a substandard seaweed-rice “cigarette”, frequently leaving a large mass of rice on one side and the filling on the other, resulting in a disarticulated mass of filling wrapped in seaweed. Multiple ingredient fillings typically cause the machines on the market to produce inconsistent roll sizes, ending in user failure, frustration, and product waste.

As can be seen, there is a need for an apparatus that produces a consistently high-grade sushi roll, regardless of the quantity of ingredients.

### SUMMARY OF THE INVENTION

In one aspect of the present invention, a sushi roll forming apparatus comprises a horizontal base with upstanding end walls having a parallel configuration, said upstanding end walls each having guide slots with rests formed therein; a first roller having a longitudinally extending rod at each end carried within said guide slots, slidably between the rests; a second roller having a longitudinally extending rod at each end carried within said guide slots parallel to said first roller, said second roller extending into the guide slots, slidably between the rests; and a flexible sleeve suspended around said first roller and said second roller.

In another aspect of the present invention, a method of forming a sushi roll comprises providing the sushi roll forming apparatus of claim 1; spacing the first roller from the second roller to form an assembly deck; placing nori on the assembly deck; pressing sushi rice onto the nori; distributing filler ingredients longitudinally along the nori; urging the first and second rollers together; and rotating the first and second rollers, thereby rolling the nori around the filler ingredients

The apparatus provides an advantage over past methods of simply loosely wrapping the rice and filler, which ultimately become disarticulated, the roll frequently disintegrating when the user attempts to cut the roll or consume the roll segments. The apparatus adapts to the amount of ingredients placed within the apparatus, drawing in any slack to apply pressure evenly across the full length of the ingredients deposited within, resulting in a firm and articulated sushi roll that can be easily cut and consumed.

These and other features, aspects and advantages of the present invention will become better understood with reference to the following drawings, description, and claims.

### BRIEF DESCRIPTION OF THE DRAWINGS

FIG. 1 is a top perspective view of a sushi rolling apparatus according to an embodiment of the present invention;

FIG. 2 is an exploded perspective view thereof;

FIG. 3 is a first exploded front elevation view thereof, shown in use;

FIG. 4 is a second exploded front elevation view thereof, shown in use;

FIG. 5 is a cross-sectional view thereof, shown in use;

FIG. 6 is another cross-sectional view thereof, shown in use; and

FIG. 7 is another cross-sectional view thereof, shown in use.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a sushi rolling apparatus with floating tension shafts and a variable-tension compression girdle.

The apparatus is sometimes referred to herein as the “sushi pro”.

The device is effective to compress and adhere rice to nori on an exterior of a sushi roll while compressing ingredients within the roll. It compresses the rice as effectively on the outside of the roll as on the inside, rendering the same size and level of integrity when executing any sushi roll. In addition, the sushi pro pushes out any overfill of ingredients to be reused without tearing the nori. This apparatus may also be used to create burritos, taquitos, egg rolls, sandwich wraps, lumpia, and spring rolls.

The apparatus has a platform comprising a horizontal base with sidewalls.

Independently free-floating tension shafts or roller pins attach to the sidewalls. The even pressure of the free-floating roller pins replaces a sushi chef's experience in creating a perfectly round roll with centered ingredients.

A 1-3 ingredient compression girdle or roller bag, or multiple ingredient roller bags, is suspended around the rollers. Sushi pro has multiple roll-size settings to accommodate multiple ingredient fillings. These settings include recalibrated variable-tension compression girdle sizes, resulting in perfect sushi no matter how many ingredients are selected.

In an open position, the tension shafts and variable-tension compression girdle(s) or roller bag form an assembly deck, similar to a sushi chef's large flat roll assembly workspace. The assembly workspace may have any suitable dimensions, such as about 5.5-inch×about 9.78-inch. In this open position, the tension shafts apply tension to the variable-tension compression girdle. The assembly deck enables the user to gauge the quantity of ingredients and to center them in the roll as a “sushi chef” does at a sushi restaurant. It lets the user lay the nori and rice out flat on the machine, check the rice depth, and then add ingredient by ingredient.

The sushi pro may further comprise a rice frame which enables the user to accurately gauge a consistent, even rice depth for a consistently high-quality sushi roll.

In some embodiments, a rice press or a rice roller may be used to evenly disperse the rice across the nori at an even depth beneath the edge of the rice frame.

In some embodiments, a sushi spatula may be provided to tuck ingredients deep inside the nori of a sushi roll and to evenly distribute the ingredients within the sushi roll.

The variable-tension compression girdle and the floating tension shafts adapt to the amount of ingredients placed within the apparatus, drawing in any slack in the variable-tension compression girdle to apply pressure evenly across the full length of the ingredients deposited within, resulting in a firm and articulated sushi roll that can be easily cut and consumed.

Once the apparatus has been assembled, the user may open the device to form the assembly deck. The nori may be placed on the assembly deck with the sushi roll rice frame on top of the nori. Alternatively, the user may place the rice frame on top of the assembly deck, lay nori flat inside of the rice frame, and press sushi rice to the nori using the rice press or the rice roller to evenly disperse the rice across the nori at an even depth beneath the edge of the rice frame. The user may remove the rice frame and add the filler ingredients. This leaves the nori and ingredients accessible to the user who can further organize the ingredients with a sushi pro spatula for even distribution within the sushi roll. The user may lift the roller pins, closing the roller pins around nori and ingredient-filling, compressing the ingredients. The user may then use the spatula to tuck the ingredients deep inside the nori and rotate the roller bars, sealing the ingredients inside of the nori. The user may open the tension shafts and extract a cylindrical sushi roll with an evenly spread layer of rice on the exterior of the roll and a generous quantity of centered ingredients within the roll.

For making sushi rolls that are commonly known in the art as traditional rolls, the sushi pro base, the independently, free-floating tension shafts or pins, 1-3 ingredient compression girdle or roller bag, the sushi roll rice frame, and the rice press may be used.

The nigiri frame and the rice press or rice roller bar may be used to make nigiri.

The ship roll frame, the rice press, or the rice roller bar may be used to make ship rolls.

Without limiting the materials or method of manufacture, this sushi making apparatus may be cut, for example, from acrylic sheet and acrylic rods of ¾ inch and ⅜ inch, as well as polyethylene vinyl acetate (PEVA) food-grade sheeting. Using a scroll saw and drill press or a Computer Numerical Control (CNC) machine, the sheeting and/or rods may be cut to predetermined dimensions and the components may be assembled.

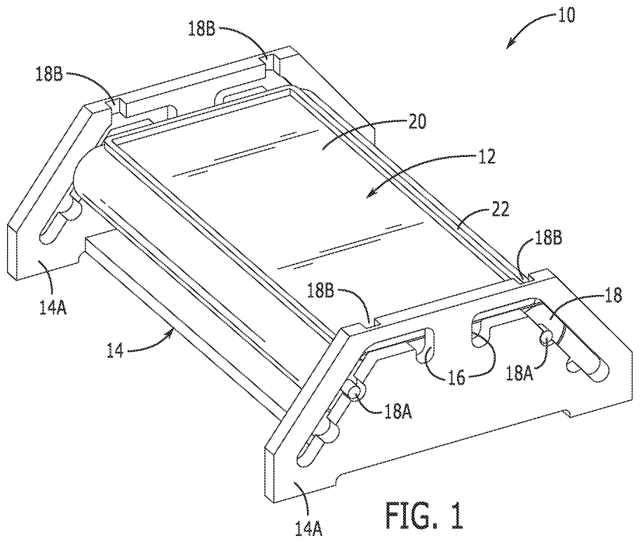

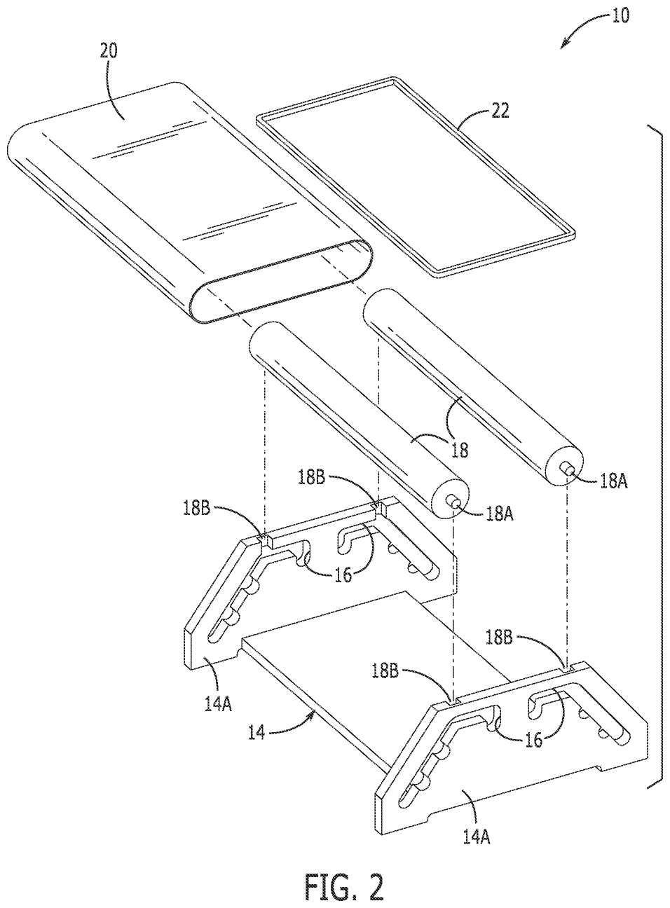

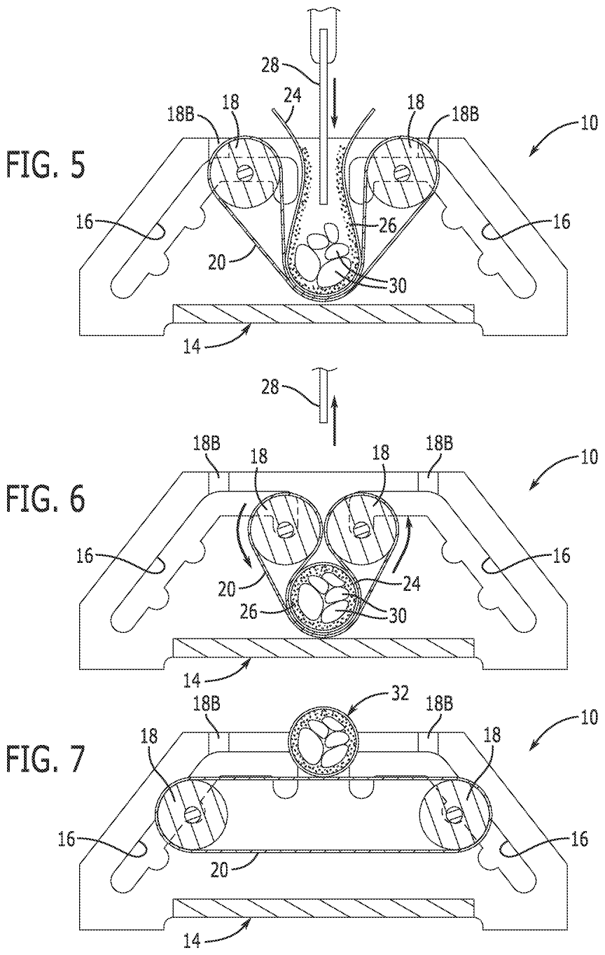

Referring to FIGS. 1 through 7, FIG. 1 illustrates a sushi roll-forming apparatus 10 according to an embodiment of the present invention having a horizontal, rectangular base 14 with sidewalls 14A or parallel upstanding end walls rising from each end of the base 14 and a flexible, cylindrical roller bag 20 or flexible sleeve suspended between cylindrical roller pins 18 to form an assembly deck 12; see FIG. 2. The sidewalls 14A are parallel and have a truncated triangular profile, such that each sidewall 14A has a horizontal top edge and two parallel vertical edges. The guide slots run parallel to the edges of the end walls. The roller pins 18 have guideposts 18A or longitudinally extending rods extending longitudinally from each end which are accommodated by guide slots 16 formed in the sidewalls 14A. The guide slots 16 extend adjacent to the edges of the sidewalls 14A. Receiving slots 18B formed in the sidewalls 14A descend from the top edge to a horizontal portion of the guide slots 16. The apparatus 10 is shown in FIG. 1 with a rice frame 22 configured to rest upon the assembly deck 12. Note that the sidewalls 14A have three indentations or rests formed in the guide slots 16 serving as positions in which the roller pin 18 guideposts 18A may rest.

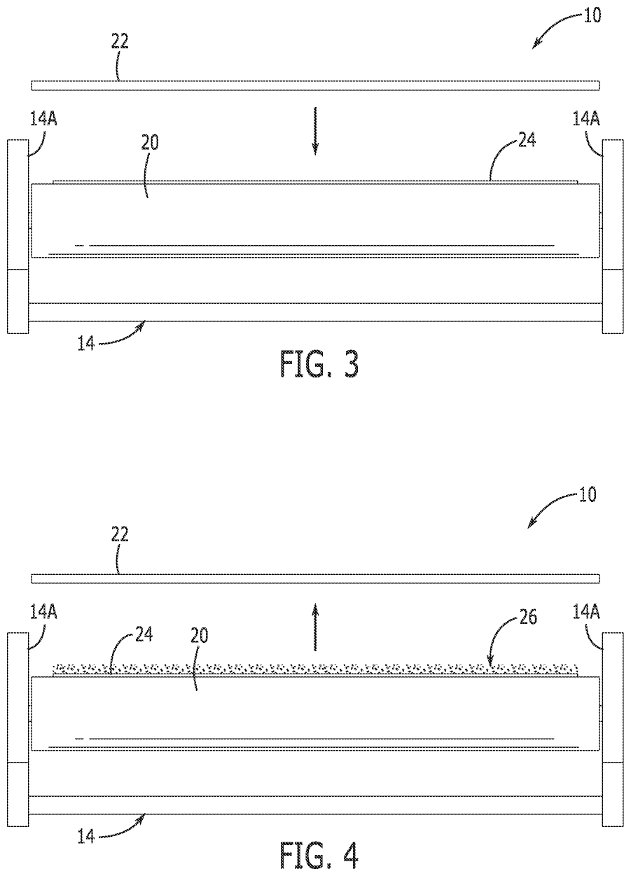

FIGS. 3 through 7 illustrate use of the apparatus 10. As shown in FIG. 3, with the guideposts 18A resting in the middle guide slot 16 positions, nori 24 may be placed on the roller bag 20 and the rice frame 22 may be placed over the nori 24. The user may spread rice 26 across the nori 24 and lift away the rice frame 22, as seen in FIG. 4. Dislodging the guideposts 18A from the middle resting positions, the user may urge the rollers 18 together, simultaneously using a sushi spatula 28 to urge roll ingredients 30 into a pocket formed by the rice 26 coated nori 24. With the guideposts 18A resting in the top guide slot 16 positions, i.e., closest together, the rollers 18 may be rotated, rolling the nori 24 around the ingredients 30. Once the nori 24 has rotated fully around the ingredients 30, the rollers 18 may be dislodged from the upper guide slot 16 positions and urged into the middle guide slot 16 positions farther apart, such that the roller bag 20 again forms an assembly deck 12 with a fully assembled sushi roll 32 resting thereupon.

It should be understood, of course, that the foregoing relates to exemplary embodiments of the invention and that modifications may be made without departing from the spirit and scope of the invention as set forth in the following claims.

What is claimed is:

1. A sushi roll forming apparatus, comprising:
a) a horizontal base with upstanding end walls having a parallel configuration, said upstanding end walls each having guide slots with rests formed therein;
b) a first roller having a longitudinally extending rod at each end carried within said guide slots, slidably between the rests;
c) a second roller having a longitudinally extending rod at each end carried within said guide slots parallel to said first roller, said second roller extending into the guide slots, slidably between the rests; and
d) a flexible sleeve suspended around said first roller and said second roller.

2. The sushi roll forming apparatus of claim 1, wherein the upstanding end walls have a truncated triangular profile, the guide slots extend parallel to edges of the truncated triangular profile, and receiving slots descend from a top edge of each end wall to a horizontal portion of the guide slots.

3. The sushi roll forming apparatus of claim 1, further comprising a spatula configured to pass between the first roller and the second roller when urged together within the guide slots.

4. The sushi roll forming apparatus of claim 1, wherein said flexible sleeve forms an assembly deck when the first roller and the second roller are urged apart within the guide slots.

5. The sushi roll forming apparatus of claim 4, further comprising a rice frame configured to rest upon the assembly deck.

6. A method of forming a sushi roll, comprising:
providing the sushi roll forming apparatus of claim 1;
spacing the first roller from the second roller to form an assembly deck;
placing nori on the assembly deck;
pressing sushi rice onto the nori;
distributing filler ingredients longitudinally along the nori;
urging the first and second rollers together; and
rotating the first and second rollers, thereby rolling the nori around the filler ingredients.

7. The method of claim 6, further comprising spacing the first roller from the second roller after rotating the first and second rollers; and extracting the sushi roll from the assembly deck.

8. The method of claim 6, further comprising after urging the first and second rollers together, tucking the filler ingredients inside the nori with a spatula.

9. The method of claim 6, further comprising placing a rice frame on the nori; spreading the sushi rice across the nori; and lifting the rice frame away prior to pressing the sushi rice onto the nori.

10. The method of claim 6, further comprising dislodging the first roller and the second roller from the rests prior to urging the first and second rollers together.
